(19) United States
(12) Patent Application Publication
(10) Pub. No.: US 2017/0122545 A1
(43) Pub. Date: May 4, 2017

(54) LIGHT MODULE AND LAMP THEREOF

(71) Applicant: LUMION TECH CO., LTD., TAIPEI CITY (TW)

(72) Inventors: HSIEH-CHIA CHEN, TAINAN CITY (TW); YI-SUNG HUNG, NEW TAIPEI CITY (TW); CHIEN-WEN HO, TAOYUAN COUNTY (TW)

(21) Appl. No.: 15/012,906

(22) Filed: Feb. 2, 2016

(30) Foreign Application Priority Data
Oct. 30, 2015 (TW) 104217400

(51) Int. Cl. F21V 31/04; F21V 23/00; F21V 19/00

(52) U.S. Cl. CPC F21V 31/04; F21V 19/002; F21V 23/002; F21Y 2115/10

(57) ABSTRACT

The disclosure is related to a light module, comprising a circuit board, at least one light unit, a power conversion unit, a plurality of power cords and an encapsulating material. At least one light unit is disposed on the circuit board. The power conversion unit is disposed on the circuit board. A plurality of power cords is coupled between the power conversion unit and at least one light unit. The encapsulating material is for encapsulating at least one light unit, the power conversion unit and the power cords.

### BACKGROUND

1. Technical Field

The present invention is related to a light module and lamp thereof; in particular to the light module configured in the circuit board, and lamp using the light module.

2. Description of Related Art

The LED has the advantage of saving energy for a variety of lighting applications indoors or outdoors. The LED is gradually replacing the conventional fluorescent bulb or fluorescent lamp, and the LED has become the new generation of light source. Because single light emitting diodes can provide finite light intensity, light emitting diodes usually are configured in serial, parallel or serial and parallel combination to form a light module providing sufficient light intensity in a particular location.

For convenience of explanation, the conventional light-emitting device of the present embodiment is a conventional bulb 8, 9. FIG. 1 shows a perspective diagram of a conventional light-emitting device. Please refer to FIG. 1. The conventional bulb 9 includes a conventional light module 90, a driver module 92, a lampshade 94 and a lamp housing base 96. The conventional light module 90 is a light board with a plurality of light emitting diodes. The said light board does not implement encapsulation operations with Chip On Board. In addition, the lamp housing base 96 has a heat dissipation structure.

In addition, FIG. 2 shows a perspective diagram of a conventional light-emitting device. Please refer to FIG. 2. The conventional bulb 8 includes a conventional light module 80, a heat dissipation structure 81, a driver module 82, a lampshade 84 and lamp housing base 86. The conventional light module 80 is an encapsulating structure of a Chip On Board with a plurality of light emitting diodes.

However, whether the conventional light module 90 is the light board without an encapsulation operation of a Chip On Board or a conventional light module 80 is an encapsulating structure of a Chip On Board with a plurality of LEDs, the conventional light-emitting device has the problems of poor heat dissipation, not waterproof, not dustproof and inability to protect against electric shock. Further, the conventional light-emitting device has problems with multiple components and a complex structure as shown as FIG. 1 and FIG. 2.

### SUMMARY

The present invention provides a light module based on encapsulating the power conversion unit and the light units to form an encapsulating structure, while the light module achieves the useful conveniences of waterproofing, dustproofing and protection against electric shock.

The present invention provides a light module, comprising a circuit board, at least one light unit, a power conversion unit, a plurality of power cords and an encapsulating material. At least one light unit is disposed on the circuit board. The power conversion unit is disposed on the circuit board. A plurality of power cords is coupled between the power conversion unit and at least one light unit. The encapsulating material is for encapsulating at least one light unit, the power conversion unit and the power cords.

The present invention provides a lamp with the light module.

The specific means of the present invention using a light module is based on encapsulating the power conversion unit and the light unit to form an encapsulating structure. Therefore, the power conversion unit avoids contact or attachment of moisture, water or dust to achieve the effect of waterproofing, dustproofing and protection against electric shock, etc. Furthermore, the light module of the present embodiment can adjust the angle or RA-color of illumination in the encapsulating structure. The useful convenience of the light module in the present invention is enhanced.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

FIG. 1 shows a perspective diagram of a conventional light device;

FIG. 2 shows a perspective diagram of a conventional light device;

FIG. 3 shows a top view of the light module according to an embodiment of the present invention;

FIG. 4 shows a cross-sectional schematic view of the light module according to FIG. 3 embodiment of the present invention;

FIG. 5 shows a functional diagram of the light module according to another embodiment of the present invention;

FIG. 6 shows a functional diagram of the light module according to another embodiment of the present invention; and

FIG. 7 shows a top view of the light module according to an embodiment of the present invention.

### DESCRIPTION OF THE EXEMPLARY EMBODIMENTS

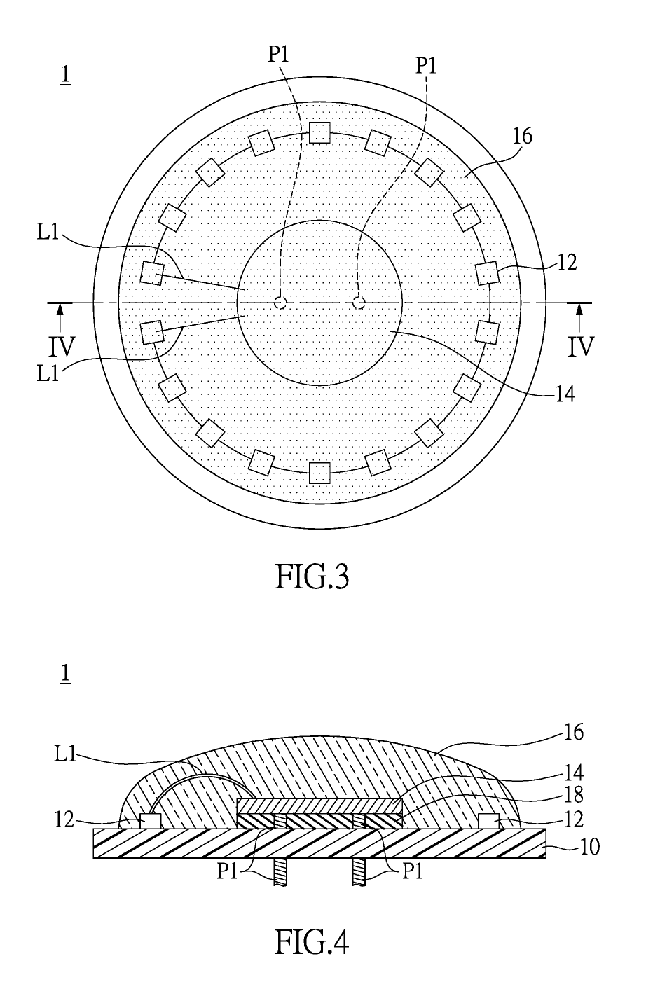

FIG. 3 shows a top view of the light module according to an embodiment of the present invention. FIG. 4 shows a cross-sectional schematic view of the light module according to the embodiment of the present invention shown in FIG. 3. A light module 1 comprises a circuit board 10, at least one light unit 12, a power conversion unit 14, a plurality of power cords L1 and an encapsulating material 16.

For convenient explanation, the light module 1 is lighting equipment. In another embodiment, the light module 1 for instance can be a display panel, a backlight, car lighting equipment or other equipment. The type or application of the light module 1 is not limited in the present embodiment.

The power conversion unit 14 through the power cords L1 is electrically connected to the at least one light unit 12. The at least one light unit 12 and the power conversion unit 14 are all configured on the circuit board 10. Thus, the encapsulating material 16 encapsulates at least one light unit 12, the power conversion unit 14 and the power cords L1 to form an encapsulating structure with the at least one light unit 12 and the power conversion unit 14. The type of the light module 1 is not limited in the present embodiment.

For convenient explanation, the at least one light unit 12 for instance can be multiple LEDs in series, parallel or series and parallel combinations. In another embodiment, the light unit 12 for instance can be an LED, or the light unit 12 for instance can be an LED chip, an OLED chip or a laser diode chip. The type or quantity of the light unit 12 is not limited in the present embodiment. It is noted that the at least one light unit 12 based on surface mount technology connects to a printed circuit board.

In detail, the circuit board 10 for instance can be a circuit board with preformed circuit, flexible printed circuit board, monolayer printed circuit board or multilayer printed circuit board. The printed circuit board can be aluminum-based material, FR4 flame grade material, polyimide film, ethylene terephthalate (PET) film, a glass substrate or a ceramic substrate. The type of the circuit board 10 and the printed circuit board is not limited in the present embodiment.

The power conversion unit 14 is for converting AC power to DC power, and supplies DC power to the light units 12, so as to drive the light unit 12 emitting light. The power conversion unit 14 for instance can be a power conversion and driver circuit, power driver circuit or power conversion circuit. The type of the power conversion unit 14 is not limited in the present embodiment.

In addition, the power conversion unit 14 is implemented by at least one or combinations of a rectifier circuit, a filter circuit, a buck circuit, a boost circuit, a buck-boost circuit, constant-voltage driver chip, constant-current driver chip and pulse driver circuit. The rectifier circuit is for converting AC power to DC power. The buck circuit, the boost circuit or the buck-boost circuit is designed based on driving voltage and current of the light unit 12. The constant-voltage driver chip, the constant-current driver chip or pulse driver is controlled by a constant-voltage method, constant-current method or PWM method to control the light unit 12 emitting light.

It is worth mentioning that the encapsulating structure with the light unit 12 and the power conversion unit 14 is different from conventional light device. The power conversion unit 14 and the light unit 12 are encapsulated together. Thus, the power conversion unit 14 avoids contact or attachment of moisture, water or dust to achieve the effect of waterproofing, dustproofing and protection against electric shock, etc.

The power cords L1 are coupled between the power conversion unit 14 and at least one light unit 12. Practically, the quantity of the power cords L1 is designed according to the power distribution conditions with the light units 12 and the power conversion unit 14 in series, parallel or series and parallel combinations. For example, the light units 12 are in series as shown as FIG. 3, the first one light unit 12 and the last one light unit 12 in series through power cord L1 are coupled to the power conversion unit 14, respectively. The power conversion unit 14 has a plurality of welded points to couple to the power cords L1.

Furthermore, the power cords L1 for instance can be metal wires. The power cords L1 are electrically connected to the light units 12 and to the power conversion unit 14 by wire bonding. In another embodiment, the light units 12 are in parallel, each light unit 12 through each power cord L1 is electrically connected to the power conversion unit 14. In the other words, the power conversion unit 14 has multiple welded points, and the welded points are welded to the power cord L1, respectively. The light units 12 are in series and parallel combinations, the power conversion unit 14 has a plurality of welded points corresponding to the light units 12. The quantity of welded points of the power conversion unit 14 is not limited in the present embodiment.

In another embodiment, it is worth mentioning that the power cords L1 are traces, conductive wire or a circuit of the pre-formed circuit of a circuit board 10. This is different from power cord formed by wire bonding in this present embodiment. One skilled in the art would know traces, conductive wire or a circuit of the pre-formed circuit. The type of the power cord L1 is not limited in the present embodiment. The encapsulating material 16 is for encapsulating the light units 12, the power conversion unit 14 and the power cords L1. Practically, the encapsulating material 16 for instance can be silicone, epoxy resin or epoxy resin mixture. The type of the encapsulating material 16 is not limited in the present embodiment. For example, epoxy resin after heating will have reduced viscosity for a period to help the flow of epoxy resin. Therefore, the user could use the automatic dispenser or preheat needle to encapsulate the light units 12, the power conversion unit 14 and the power cords L1. After the epoxy resin solidifies, the encapsulating material 16 will form a protective layer.

In addition, the power input unit P1 for instance can be one or a combination of metal wire and metal conductive studs. Practically, the power input unit P1 forms the power input unit based on metal conductive studs using embedded or wire bonding. In the present embodiment, the power conversion unit 14 is configured in an intermediate position of the encapsulating structure. The power conversion unit 14 through power input unit P1 such as metal conductive studs or metal conductive wire is coupled to AC utility power or DC power. DC power for instance can be vehicle power, battery power or other power.

In another embodiment, the power conversion unit 14 is configured in an edge position within the encapsulating structure. The power conversion unit 14 based on a wire bonding method has a plurality of power input units, wherein the power input unit P1 is for electrically connecting to AC power or DC power. The power input unit P1 is implemented by a power cord, power supply terminal, headlight copper needles or power outlet. The type of the power input unit P1 is not limited in the present embodiment.

The encapsulating material 16 as shown in FIG. 4 solidified forms an arc-shaped protective layer. In other embodiments, the encapsulating material 16 solidified forms a flat protective layer, or the encapsulating material 16 solidified forms a high convex protective layer. In the other words, the cross-sectional view of the encapsulating material 16 may be cylindrical, semi-cylindrical, cylindrical type, cylindrical class type, a triangle type, a triangle class type, trapezoid type, square type, rectangular type or other type of cross-sectional shape. Thus, the light unit 12 in the encapsulating structure corresponding to different cross-sectional views of the encapsulating material 16 emits lights with different illumination angles. In other words, the light module 1 of the present embodiment can adjust the angle of illumination in the encapsulating structure.

In addition, transparent encapsulating material 16 can further add a fluorescent substance or other chromogenic material, so the solidified encapsulating material 16 forms a protective layer with converting light wavelength ability. The solidified encapsulating material 16 is for converting light wavelength emitted by the light unit 12. The fluorescent substance may be fluorescent powder with yttrium aluminum garnet (YAG) class, silicate class, nitride class, phosphors class, oxide class or aluminum oxides class. In other words, the light module 1 can have any adjustment of RA-color.

It is noted that the power conversion unit 14 of the present embodiment through the insulating layer 18 connects to a printed circuit board, and the light unit 12 is directly connected to a printed circuit board. In another embodiment, the power conversion unit 14 and the light units 12 all through the insulating layer 18 connect to the printed circuit board, or one or some of the light units 12 and the power conversion unit 14 through the insulating layer 18 connect to the printed circuit board, or the light units 12 and the power conversion unit 14 all directly connect to the printed circuit board. One skilled in the art could freely design the electrical connection status with the light units 12, the power conversion unit 14 and printed circuit board.

On the basis of the above, the present embodiment based on encapsulating technique encapsulates the light unit 12, the power conversion unit 14 and the power cords L1 to form a protective layer, so as to achieve the effect of waterproofing, dustproofing or anti-high-pressure leakage. The encapsulating structure with the light units 12 and the power conversion unit 14 is very light and thin Thus, production, assembly and manufacturing the light-emitting device, lamp or bulb becomes convenient. Furthermore, the light module 1 of the present embodiment really solves problems that existed in the conventional light-emitting device with poor heat dissipation, such as not waterproof, dustproof, unable to protect against electric shock, multiple components and complex structure.

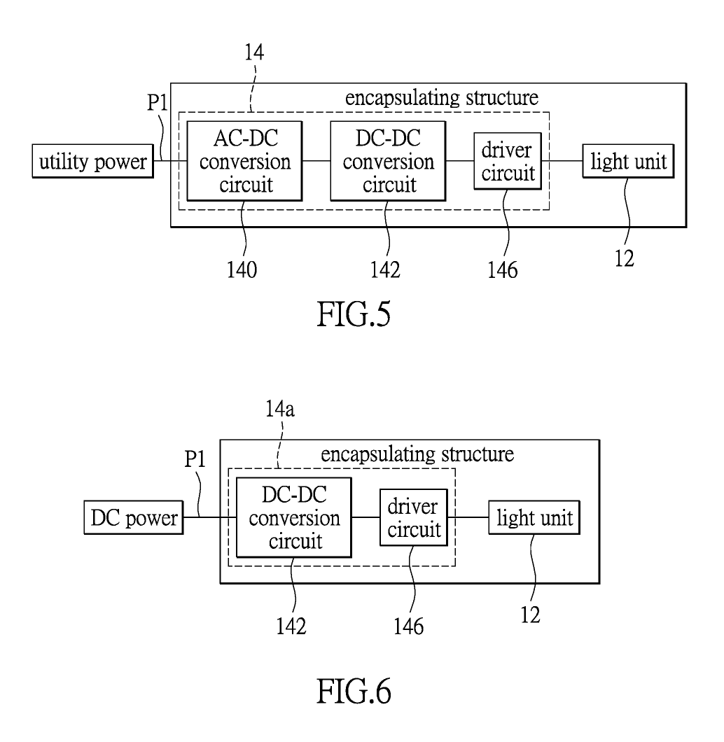

FIG. 5 shows a functional diagram of the light module according to another embodiment of the present invention. Please refer to FIG. 5. The power conversion unit 14 of the light module in FIG. 5 comprises an AC-DC conversion circuit 140, a DC-DC conversion circuit 142 and a driver circuit 146. In detail, the DC-DC conversion circuit 142 is coupled to the AC-DC conversion circuit 140 and the driver circuit 146. The AC-DC conversion circuit 140 is coupled to utility power. The driver circuit 146 is coupled to at least one light unit 12. The type of the light module 1 is not limited in the present embodiment.

In detail, the AC-DC conversion circuit 140 for instance can be a rectifier circuit or rectifier. The DC-DC conversion circuit 142 for instance can be a buck circuit, boost circuit or buck-boost circuit. The driver circuit 146 for instance can be constant-voltage driver chip, constant-current driver chip or pulse driver circuit. The type of the AC-DC conversion circuit 140, the DC-DC conversion circuit 142 and the driver circuit 146 is not limited in the present embodiment.

In simple terms, the present embodiment based on the thin and light circuit design of the power conversion unit 14 encapsulates the power conversion unit 14 and the light units 12 to form an encapsulating structure. The said encapsulating structure with the power conversion unit 14 and the light units 12 achieves the effect of waterproofing, dustproofing and protection against electrical shock. In addition, the light module 1 of the present embodiment has the ability of adjusting for any angle of illumination or RA-color of illumination. One skilled in the art can use the light module 1 of the present embodiment to apply it to a lamp, bulb, light-emitting device or other illumination apparatus.

FIG. 6 shows a functional diagram of the light module according to another embodiment of the present invention. Please refer to FIG. 6. The power conversion unit 14a of the light module in FIG. 6 comprises a DC-DC conversion circuit 142 and a driver circuit 146. In other words, the light module of the present embodiment can be coupled to DC power, and applies to headlights, automotive lighting, a display panel, backlight, or other device using a DC power supply. The remaining parts of the light module are the same and are not described repeatedly. The type of the light module is not limited in the present embodiment.

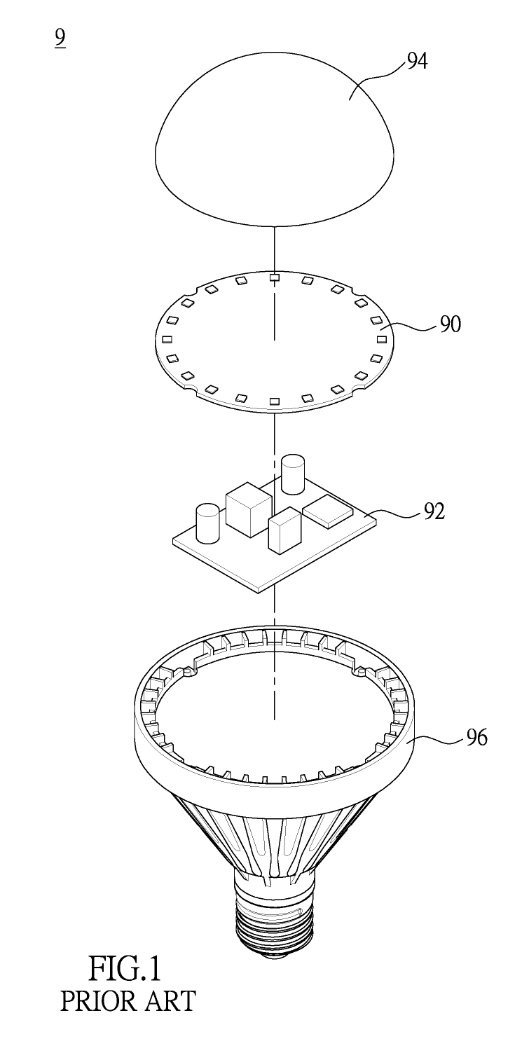

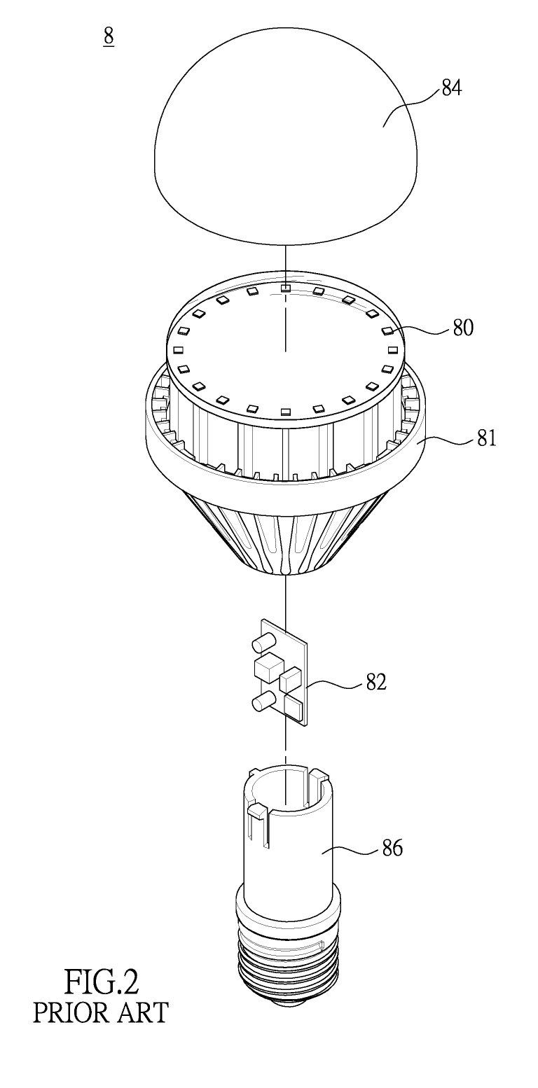

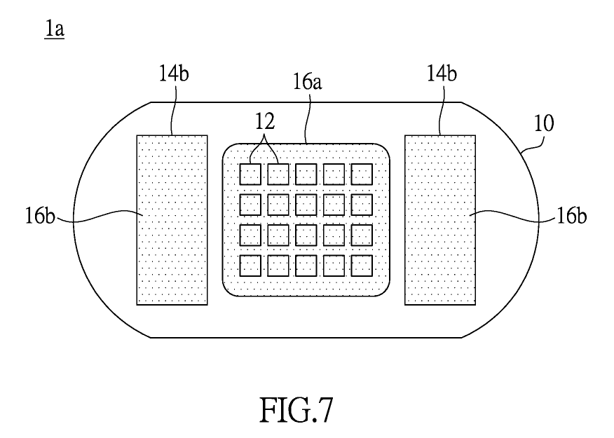

FIG. 7 shows a top view of the light module according to an embodiment of the present invention. Please refer to FIG. 7. The light modules 1a in FIGS. 7 and 1 in FIG. 1 have similar structure. The difference between both the light modules la and 1 is the configured location of the light units 12 and the power conversion unit 14b. In the present embodiment, the light units 12 are disposed in the central region of the circuit board 10, and the power conversion unit 14b is disposed on the left side and right side of the circuit board 10.

Practically, the light unit 12 through encapsulating material 16a forms an encapsulating structure; the power conversion unit 14b disposed on the left side and right side through encapsulating material 16b forms another encapsulating structure. In the other words, the light unit 12 and the power conversion unit 14b individually implement an encapsulating operation respectively, so as to form three independent encapsulating structures. In another embodiment, the power conversion unit 14b disposed on the left side and right side could not be implemented an encapsulating operation, or the light unit 12 and the power conversion unit 14b could implement an encapsulating operation together, or the power conversion unit 14b could be disposed on one left side or right side, upper side, lower side, one of the upper side or lower side, four sides with left side, right side, upper side and lower side. The light units 12 and the power conversion unit 14b are designed in the circuit board 10 based on the user's requirements. One skilled in the art freely designs the configured type of the light units 12 and the power conversion unit 14b.

In summary, the present invention is a light module for encapsulating the power conversion unit and the light unit to form an encapsulating structure. Thus, the encapsulating structure of the power conversion unit and the light unit avoids contact or attachment of moisture, water or dust to achieve the effect of waterproofing, dustproofing and protection against electric shock, etc. In addition, the light module of the present embodiment has the ability of adjusting the any angle of illumination or RA-color of illumination. The encapsulating material through the automatic dispenser or preheat needle adheres to the circuit board, the light units and the power conversion unit, so as to form a variety of forms and shapes of the protective layer. As a result, the light module really overcomes the problems of conventional light-emitting device such as poor heat dissipation, not waterproof, dustproof, unable to provide protection against electric shock, multiple components and complex structure. The present invention really enhances the useful convenience of the light module.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A light module, comprising:
a circuit board;
at least one light unit, configured in the circuit board;
a power conversion unit, configured in the circuit board;
a plurality of power cords, electrically connected to the power conversion unit and the at least one light unit; and
an encapsulating material, being for encapsulating the at least one light unit, the power conversion unit and the power cords.

2. The light module according to claim 1, wherein the power conversion unit comprises an AC-DC conversion circuit, a DC-DC conversion circuit and a driver circuit; the DC-DC conversion circuit is electrically connected to the AC-DC conversion circuit and the driver circuit, the AC-DC conversion circuit is coupled to utility power, and the driver circuit is electrically connected to the at least one light unit.

3. The light module according to claim 2, wherein the AC-DC conversion circuit is a rectifier circuit, the DC-DC conversion circuit is one or a combination of a boost circuit, a buck circuit and a buck-boost circuit; the driver circuit is one of a constant-voltage driver chip, a constant-current driver chip and a pulse driver chip.

4. The light module according to claim 1, wherein the power conversion unit comprises a DC-DC conversion circuit and a driver circuit, the DC-DC conversion circuit is electrically connected to the driver circuit and DC power; the driver circuit is electrically connected to the at least one light unit.

5. The light module according to claim 1, wherein the power conversion unit has a plurality of welded points for electrically connecting to the power cords or a plurality of the power input units, the at least one light unit is a single LED, or multiple LEDs in series, parallel or series and parallel combinations.

6. The light module according to claim 1, wherein the circuit board is a printed circuit board, the printed circuit board is aluminum-based material, FR-4 flame grade material, polyimide film, ethylene terephthalate (PET) film, a glass substrate or a ceramic substrate.

7. The light module according to claim 6, wherein the power conversion unit through an insulating layer connects to the printed circuit board.

8. The light module according to claim 6, wherein the at least one light unit based on surface mount technology connects to the printed circuit board.

9. The light module according to claim 1, wherein the encapsulating material is silicone, epoxy resin or epoxy resin mixture.

10. A Lamp comprising the light module according to claim 1.
